(19) United States
(12) Patent Application Publication
(10) Pub. No.: US 2017/0167569 A1
(43) Pub. Date: Jun. 15, 2017

(54) Centrally Tethered Flywheel for Energy Storage

(71) Applicants: George H. Rawitscher, Storrs, CT (US); Justin D. Hall, Wallingford, CT (US)

(72) Inventors: George H. Rawitscher, Storrs, CT (US); Justin D. Hall, Wallingford, CT (US)

(21) Appl. No.: 15/373,611

(22) Filed: Dec. 9, 2016

Related U.S. Application Data
(60) Provisional application No. 62/265,732, filed on Dec. 10, 2015.

(51) Int. Cl. F16F 15/315

(52) U.S. Cl. CPC F16F 15/3153

(57) ABSTRACT

Disclosed herein is a flywheel comprising at least one mass, and at least one cable encompassing the outside of the at least one mass, wherein the at least one cable is configured to generate an opposing restraining force to the centripetal force generated from rotational motion of the at least one mass. Corresponding methods and systems also are disclosed.

### FIELD OF THE INVENTION

The invention relates to flywheels as energy storage devices.

### BACKGROUND

A flywheel is a mechanical energy storage device. A flywheel stores kinetic energy through the rotation of a mass about an axis. Historically, the mass comprised a disc of large diameter with spokes and a heavy metal rim. Today, flywheels come in various shapes, sizes and materials but still operate under the same principle. Energy is transferred to a flywheel by applying a torque which increases its rotational speed. The weight of the rotating mass wants to continue to rotate unless a force acts upon it. Newton's first law of motion tells us that a moving object will tend to continue moving unless a force acts on it. Therefore, to extract the energy stored in the rotation of the mass, a torque is applied through a mechanical load. The application of the mechanical load decreases the flywheel's rotational speed.

Applications for flywheels include providing continuous energy where an energy source may be intermittent, providing a stable source of continuous energy, and even controlling orientation of mechanical systems. Another application of a flywheel includes storing energy in the flywheel over a period of time and then releasing the energy quickly. In some cases the energy released is at rates beyond the ability the continuous energy source. In other words a flywheel can provide impulses of energy beyond the amplitude of continuous energy sources. A common application for flywheels is within reciprocating engines because the torque generated from the engine is intermittent.

To achieve the goal of energy storage and delivery, flywheels typically rotate on bearings at several thousand RPMs. The amount of energy a flywheel can store is a function of the flywheel's moment of inertia (I) and angular velocity (ω). The moment of inertia is effectively the amount and distribution of the mass that is rotated in relation to the point it rotates around. The angular velocity is the speed and given direction at which the flywheel rotates.

A flywheel can store more energy if it has more mass positioned away from its center or if it rotates at a higher speed. If the mass of a flywheel is simply doubled then the moment of inertia is doubled and therefore will store twice as much energy when it rotates at the same speed as a flywheel that has half the moment of inertia. On the other hand, if the angular velocity of a flywheel is doubled (rotated twice as fast), then the stored energy increases quadratically and therefore quadruples. Therefore, it is advantageous for a designer wanting a flywheel capable of greater energy storage to achieve higher rotational speeds rather than increased mass and size of a flywheel design.

Unfortunately, there are limits to how much stress the material of a flywheel can endure at high speeds. The stress and strains of high speed rotation may warp, shatter or cause a flywheel to explode. Consequently, when very high speeds are desired designers must consider the type of materials used and their geometries. Therefore there is a need to overcome the above and other disadvantages.

### SUMMARY

The following summary is provided to facilitate an understanding of some of the innovative features unique to the present invention and is not intended to be a full description. A full appreciation of the various aspects of the invention can be gained by taking the entire specification, claims, drawings, and abstract as a whole.

One embodiment described herein is a flywheel having a first mass and a second mass bound together by a cable encompassing radially outside the first and second mass wherein centripetal force generated from rotational motion of the first and second mass acts in an opposing radial direction upon the first and second mass.

Another embodiment is a flywheel having a at least one mass and at least one cable encompassing the outside of the at least one mass, wherein the at least one cable is configured to generate an opposing restraining force to the centripetal force generated from rotational motion of the at least one mass.

Another embodiment described herein is a flywheel comprising a torus shaped mass, a shaft traversing the center of the torus shaped mass, and a net of cables encircling the torus shaped mass, wherein the net of cables extend around outer surfaces of the torus shaped mass while not contacting or connecting to the shaft.

Yet another embodiment is a method comprising obtaining a flywheel comprising at least one mass, and at least one cable encompassing the outside of the at least one mass, wherein the at least one cable is configured to generate an opposing restraining force to the centripetal force generated from rotational motion of the at least one mass, commencing rotation of the flywheel, and extracting energy from the rotating flywheel.

### BRIEF DESCRIPTION OF THE DRAWINGS

FIG. 1, depicts an exemplary assembly of a centrally tethered flywheel;

FIG. 2, depicts an exemplary assembly of a flywheel system with multiple centrally tethered flywheels;

FIG. 3, depicts an exemplary assembly of a flywheel system with multiple tethered masses;

FIG. 4, depicts an exemplary schematic of a cable and mass configuration;

FIG. 5, depicts an exemplary assembly of a flywheel with a ribbon shaped cable;

FIG. 6, depicts an exemplary assembly of a flywheel system with multiple ribbon cable tethered masses;

FIG. 7, depicts an exemplary assembly of a flywheel with a ribbon cable;

FIG. 8, depicts an exemplary assembly of a flywheel system with multiple ribbon cable tethered masses;

FIG. 9, depicts an exemplary assembly of a flywheel with a cable oriented tangential to the shaft;

FIG. 10, depicts an exemplary assembly of a flywheel system with multiple cable tethered masses;

FIG. 11, depicts an exemplary assembly of a flywheel with a cable perpendicularly traverses around the shaft;

FIG. 12, depicts an exemplary assembly of a flywheel system with multiple cable tethered masses;

FIG. 13, depicts an exemplary assembly of a flywheel with a cable perpendicularly traverses around the shaft;

FIG. 14, depicts an exemplary assembly of a flywheel system with multiple cable tethered masses;

FIG. 15, depicts an exemplary assembly of a flywheel system with multiple cable tethered masses contained within an enclosure;

FIG. 16A depicts a cross section of a torus shape mass bound by a net of cables connected to the central shaft;

FIG. 16B, depicts a torus shape mass anchored to the central shaft by spokes and bound by a net of cables that are not anchored to the central shaft;

FIG. 17, depicts a centrally tethered flywheel without cables;

FIG. 18, depicts an exemplary assembly of a flywheel system with a tethered mass within a vertical enclosure shown in an exploded view with said tethered mass fixed to the shaft and rotating with the shaft, and the shaft is connected to an electric motor and generator outside the vertical chamber;

FIG. 19, depicts an exemplary assembly of an underground flywheel system with a tethered mass within a vertical enclosure with said tethered mass fixed to the shaft and rotating with the shaft, and the shaft is connected to an above-ground electric motor and generator;

FIG. 20, is a graph showing the maximum storage energy of one embodiment of a dumbbell compared to that of an equivalent disk;

FIG. 21, is a graph showing the angular velocity of rotation of another embodiment of a dumbbell compared to that of an equivalent disk;

FIG. 22, is a graph showing the maximum storage energy of another embodiment of a dumbbell compared to that of an equivalent disk;

FIG. 23, is a graph showing the angular velocity of rotation of another embodiment of a dumbbell compared to that of an equivalent disk;

FIG. 24, is a table showing the maximum storage energy of one embodiment of a dumbbell compared to that of an equivalent disk;

FIG. 25, is a table showing the maximum storage energy of another embodiment of a dumbbell compared to that of an equivalent disk;

FIG. 26, is a table showing the maximum storage energy of one embodiment of a dumbbell compared to that of an equivalent torus;

FIG. 27, is a table showing the maximum storage energy of another embodiment of a dumbbell compared to that of an equivalent torus;

FIG. 28, is a table showing the maximum storage energy of another embodiment of a dumbbell compared to that of an equivalent torus.

### DETAILED DESCRIPTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a “first” element, component, region, layer, or section discussed below could be termed a “second” (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

As used herein, the term “equivalent disk” means a disk that has the same mass, outside radius and inside radius of a particular dumbbell. An inside radius of a dumbbell is the length of the rod between the two masses.

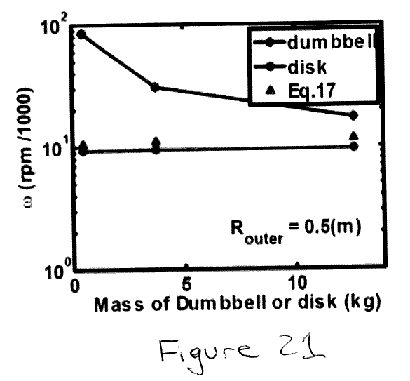

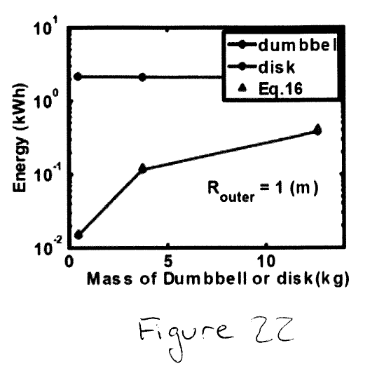

As used herein, the term “equivalent torus” means a torus that has the same outer and inner rotational radii as the ones of a particular dumbbell, as described in FIGS. 20 and 21, but the torus has the same inner circular cross sectional radius as the radii of the balls on the dumbbell, hence a larger mass than the dumbbell mass.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

In overview, the apparatus described herein relates to a centrally tethered flywheel where tethering cables provide stronger containment forces which permit larger angular rotational speeds while optimizing distribution of flywheel mass for increased moment of inertia.

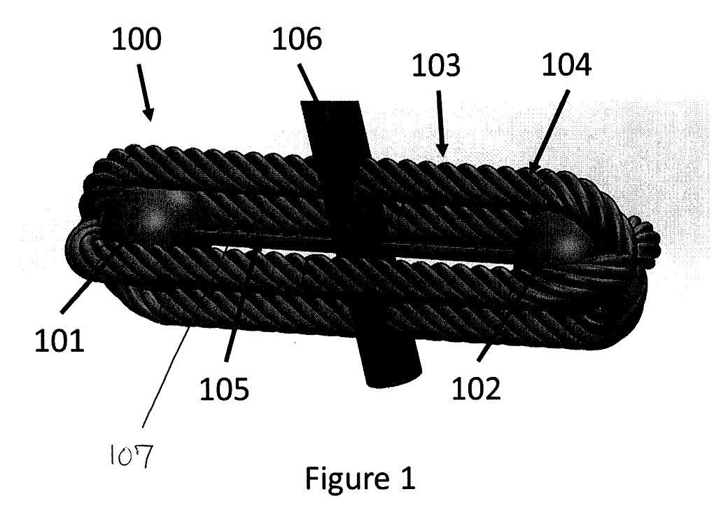

As illustrated in FIGS. 1 to 16B, a centrally tethered flywheel (100) comprises a first and second mass (101, 102) tethered together by a cable (103) about a shaft (106).

Referring to FIG. 1, an exemplary assembly of a centrally tethered flywheel is depicted. In an embodiment a flywheel system (100) comprises a first mass (101) and a second mass (102) tethered together by a cable (103). The first and second mass (101, 102) may be positioned in the same horizontal plane and equidistant from a shaft (106) located between the first and second mass (101, 102). A supporting arm (105), optionally, connects the first mass (101) and shaft (106) and connects the second mass (102) and shaft (106). The supporting arm (105) may, but in most embodiments is not intended to provide tension force during rotation of the flywheel (100). The supporting arm (105) is generally intended to locate the first and second mass (101, 102) in relation to the shaft (106) to facilitate angular acceleration. A centripetal force and a restraining force act on the first and second mass (101, 102) during rotation of the flywheel. These forces keep the first and second mass (101, 102) rotating about a central axis of shaft (106). As the angular velocity increases, the centripetal force and restraining force required to keep the first mass and second mass (101, 102) in a balanced equidistant orbit also increases. To achieve higher angular velocity the centrally tethered flywheel employs a cable (103) in a direction towards the axis of rotation and between the first and second mass (101, 102). The cable (103) directs the constraining force in the radial direction. The cable (103), optionally, does not connect the shaft (106) and the first and second mass (101, 102), the cable connects the first and second mass (101, 102) directly to each other. There is a space void (107) between the cables (103).

The cable (103) may comprise a single strand (104) of material bound around a surface of the first and second mass (101, 102) that are outward facing from the shaft (106) to prevent the first and second mass (101, 102) from moving a greater distance from the shaft (106) during rotation. The cable (103) may also, optionally, comprise multiple strands (104) twist, braided, in parallel or bound together by other means known to those in the art to form a stronger composite cable. FIG. 1 depicts a cable (103) comprising multiple strands (104) twisted together.

The cable (103) generally comprises a material having a high tensile strength. A cable (103) may comprise of carbon nanotube composite fibers having a tensile strength that is at least 3 to 5 times larger than the tensile strength of a steel cable. The first and second mass (101, 102) may comprise of a sphere of steel having uniform, size, shape and weight connected together by cable (103) comprising nanotube carbon-fiber material. Additionally, the cable (103) may comprise of steel, carbon fiber, nanotube carbon fiber or a combination thereof.

For example, a dumbbell flywheel configuration as shown in FIG. 1 allows for storing larger amounts of energy than the equivalent disk configuration. A further advantage of the dumbbell flywheel configuration over a solid disk is that the dumbbells can be added to the flywheel system incrementally.

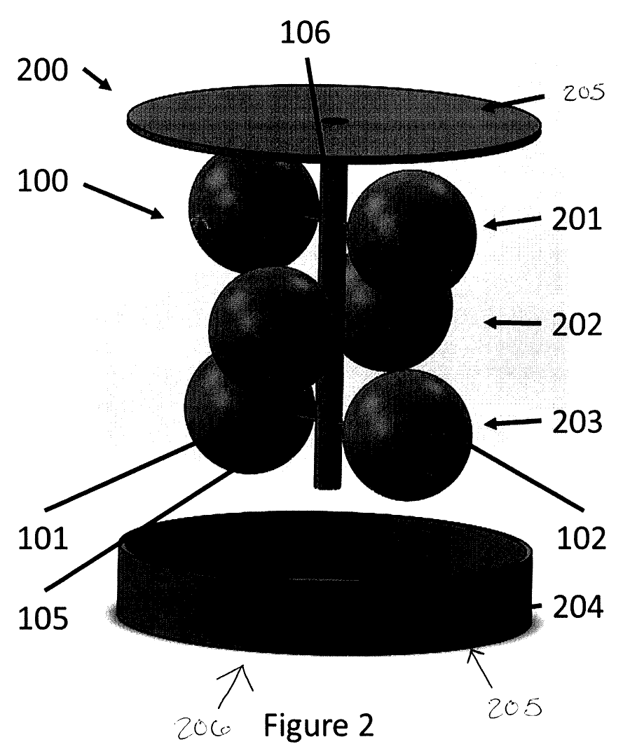

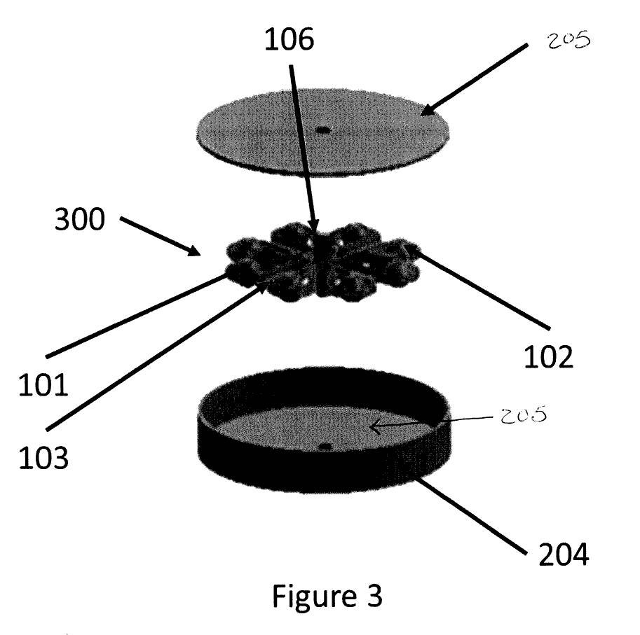

Referring to FIG. 2, an exemplary assembly of a flywheel system with multiple centrally tethered flywheels is depicted. In an embodiment, a flywheel system (200) comprises at least one flywheel (100). In other embodiments, a flywheel system (200) comprises multiple dumbbell flywheels (201, 202, 203) optionally in a stack arrangement and offset from the adjacent dumbbell flywheels (201, 202, 203). In similar embodiments, a multiple centrally tethered flywheel system may provide the flexibility to expand the energy storage capacity of a flywheel system as needed. Each additional dumbbell flywheel (201, 202, 203) adds energy storage capacity. In some embodiments, a flywheel system comprises an enclosure (206) having ends (205) and a vertical enclosure (204). The enclosure may comprise a sealed chamber that is optionally vacuum sealed to reduce air friction on the flywheel system. It should be noted that FIG. 2 omits the cables (103) required to hold the first and second mass (101, 102) in tension during rotation. The embodiment shown in FIG. 3 provides an exemplary space saving geometry.

Referring to FIG. 3, an exemplary assembly of a flywheel system with multiple tethered masses is depicted. In an embodiment, a flywheel (300) comprises multiple pairs of first and second mass (101, 102) oriented about a shaft in the same horizontal plane.

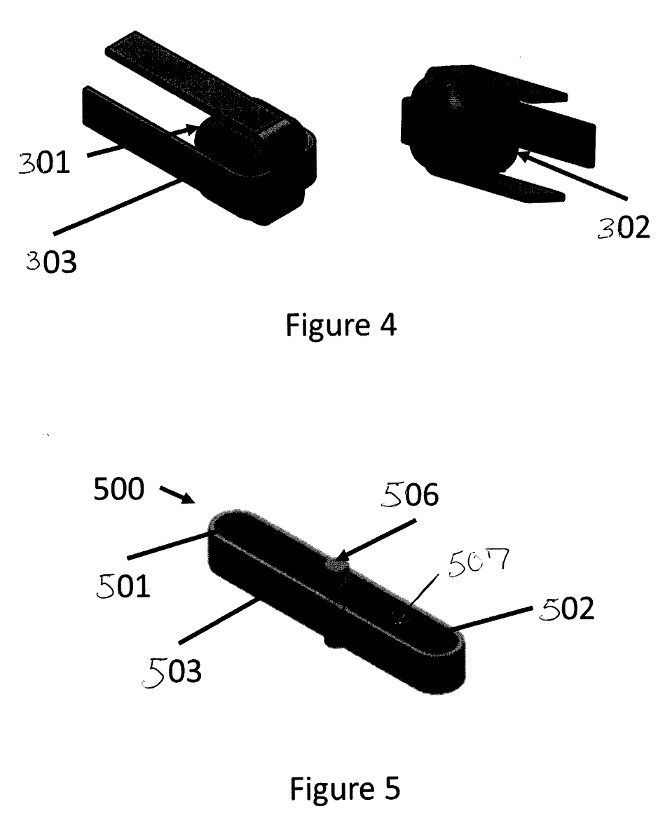

Referring to FIG. 4, an exemplary schematic of a cable and mass configuration is depicted. In an embodiment, a cable (303) may be configured in a band shape with a rectangular cross section. The first and second mass (301, 302) may comprise a cube or 3-D rectangle shape. The cable (303) may optionally form around the contour of the first and second mass on one or more facets.

Referring to FIG. 5, an exemplary assembly of a flywheel with a ribbon shaped cable is depicted. In an embodiment, a flywheel (500) comprises a first and second mass (501, 502) connected together by a ribbon shaped cable (503) oriented tangential to the shaft (506). There is a space (507) within the ribbon (507).

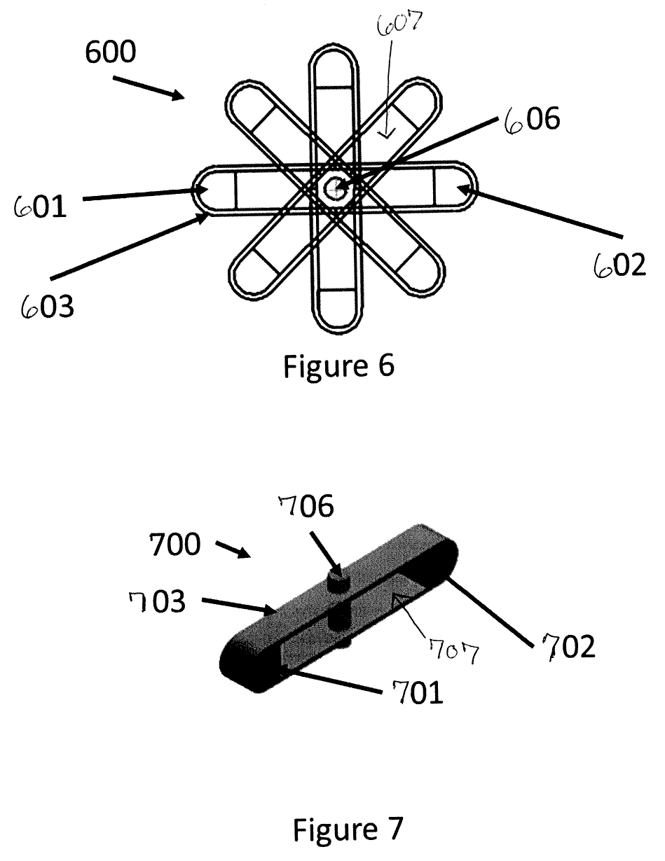

Referring to FIG. 6, an exemplary assembly of a flywheel system with multiple ribbon cable tethered masses is depicted. In an embodiment, a flywheel (600) comprises a first and second mass (601, 602) connected together by a ribbon shaped cable (603). In some embodiments, a flywheel (600) comprises multiple pairs of first and second mass (01, 602) oriented about a shaft (606) in the same horizontal plane. There is a space (607) within the ribbon cable (603).

Referring to FIG. 7, an exemplary assembly of a flywheel with a ribbon cable is depicted. In an embodiment, a flywheel (700) comprises a first and second mass (701, 702) connected together by a single ribbon shaped cable (703) oriented such that the cable perpendicularly traverses the shaft (706). There is a space (707) within the ribbon cable (603).

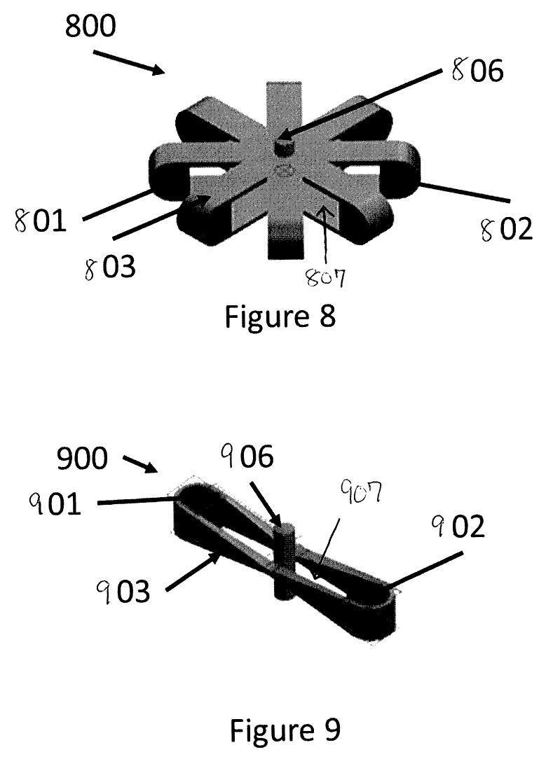

Referring to FIG. 8, an exemplary assembly of a flywheel system with multiple ribbon cable tethered masses is depicted. In an embodiment, a flywheel (800) comprises a first and second mass (801, 802) connected together by a single ribbon shaped cable (803). In some embodiments, a flywheel (800) comprises multiple pairs of first and second mass (801, 802) oriented about a shaft (806) in the same horizontal plane. There is a space (807) within the ribbon cable (803).

Referring to FIG. 9, an exemplary assembly of a. flywheel with a cable oriented tangential to the shaft is depicted. FIG. 9 depicts another alternate cable (903) configuration connecting the first and second mass (901, 902). There is a space (807) within the ribbon cable (903).

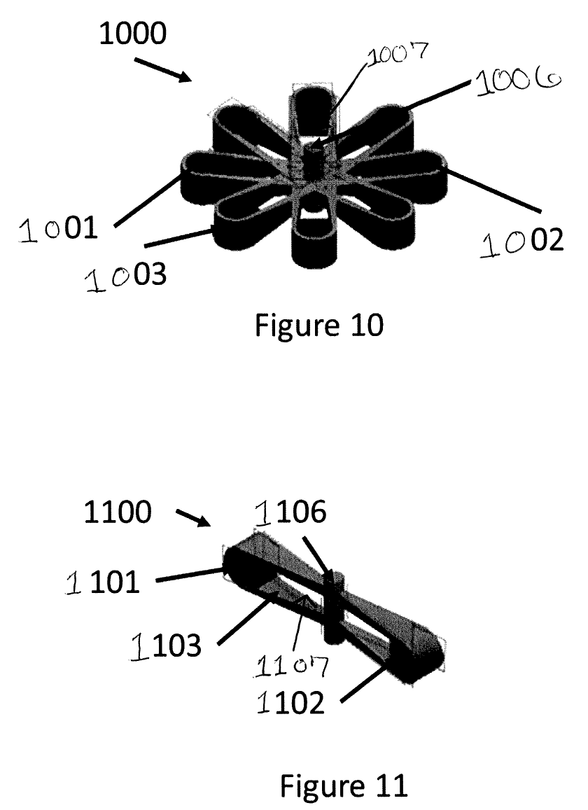

Referring to FIG. 10, an exemplary assembly of a flywheel system with multiple cable tethered masses is depicted. In an embodiment, a flywheel (1000) comprises a first and second mass (1001, 1002) connected together by a single ribbon shaped cable (1003). In some embodiments, a flywheel (1000) comprises multiple pairs of first and second mass (1001, 1002) oriented about a shaft (1006) in the same horizontal plane. There is a space (1007) within the ribbon cable (1003).

Referring to FIG. 11, an exemplary assembly of a flywheel with a cable perpendicularly traverses around the shaft is depicted. FIG. 11 depicts another alternate cable (1103) configuration connecting the first and second mass (1101, 1102). There is a space (1107) within the ribbon cable (1103).

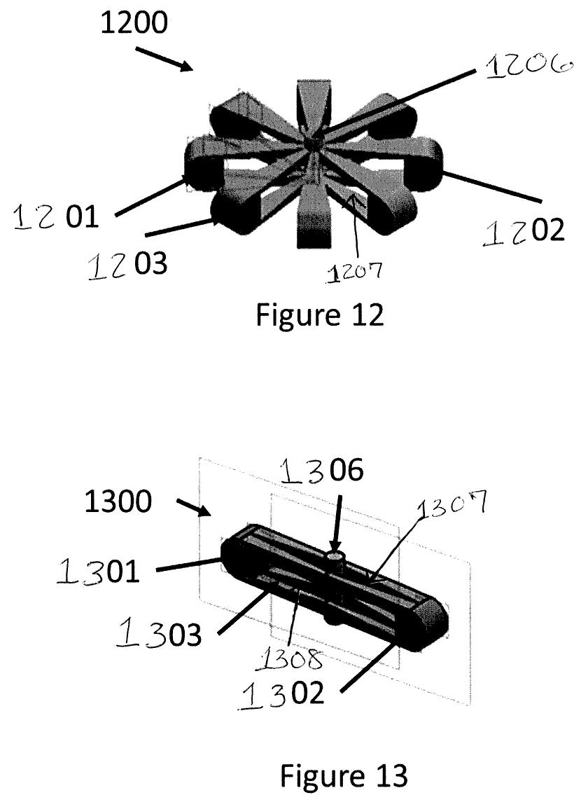

Referring to FIG. 12, an exemplary assembly of a flywheel system with multiple cable tethered masses is depicted. In some embodiments, a flywheel (1200) comprises multiple pairs of first and second mass (1201, 1202) oriented about a shaft (1206) in the same horizontal plane as shown in FIG. 12. There is a space (1207) within the ribbon cable (1203).

Referring to FIG. 13, an exemplary assembly of a flywheel with a cable that perpendicularly traverses around the shaft is depicted. FIG. 13 depicts another alternate cable (1303) configuration connecting the first and second mass (1301, 1302). There is a space (1307) on the top and bottom of the ribbon cable (1003) and there is a space (1308) on each side of the ribbon cable.

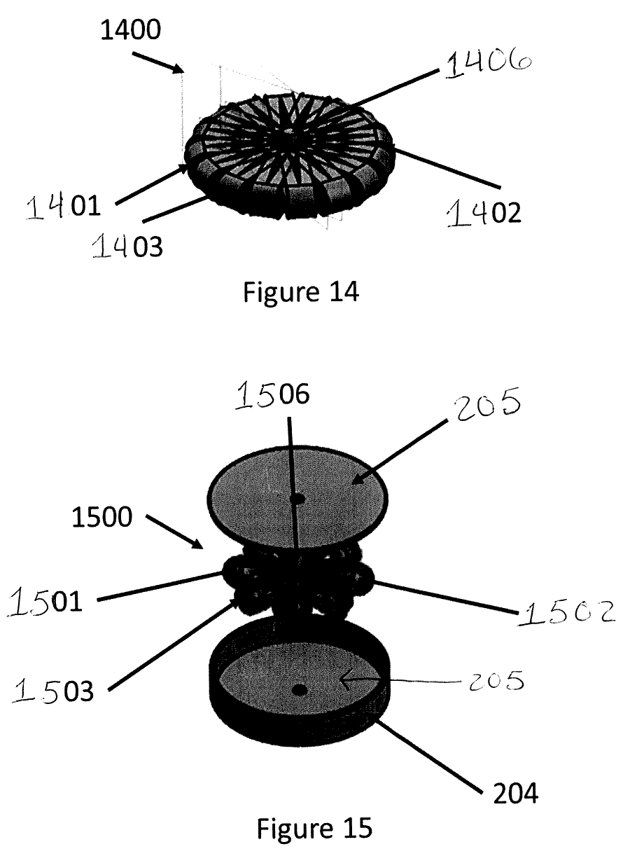

Referring to FIG. 14, an exemplary assembly of a flywheel system with multiple cable tethered masses is depicted. In some embodiments, a flywheel (1400) comprises multiple pairs of first and second mass (1401, 1402) oriented about a shaft (1406) in the same horizontal plane as shown in FIG. 14. The tethering cables are attached to a ring at the center, surrounding (and attached to) the shaft (1406).

Referring to FIG. 15, an exemplary assembly of a flywheel system with multiple cable tethered masses contained within an enclosure is depicted. In some embodiments, a flywheel (1500) comprises multiple pairs of first and second mass (1501, 1502) oriented about a shaft (1506) in the same horizontal plane as shown in FIG. 15. In particular embodiments, the cables (1503) are oriented over and around the first and second mass (1501, 1502). In further embodiments, the flywheel is contained within an enclosure having a bottom section (204) and a top section (205). The enclosure may optionally be a vacuum sealed container required to reduce the air friction on the rotation of the flywheel.

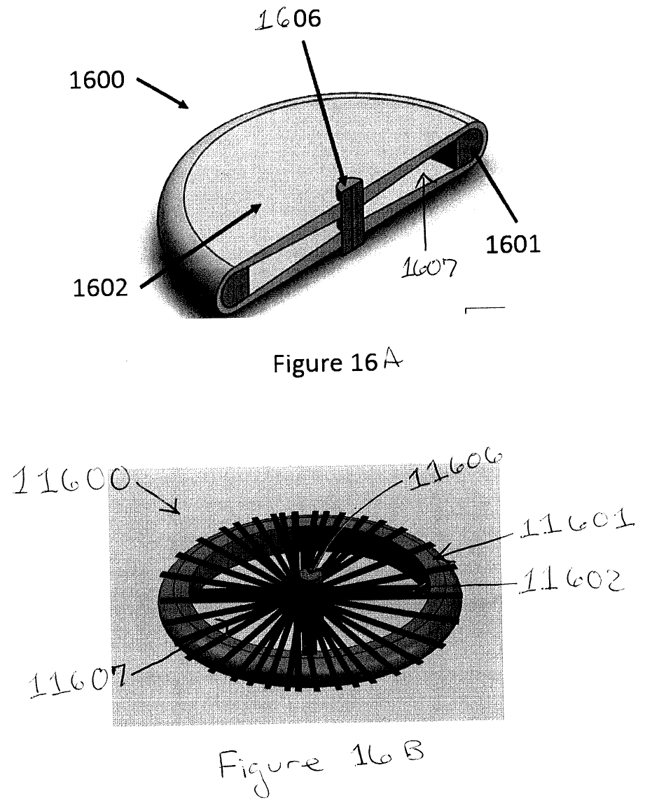

Referring to FIG. 16A, a cross section of a torus shape mass bound by a continuous net of cables is depicted. In some embodiments, a doughnut shaped flywheel (1600) comprises a torus shape mass (1601) bound to a shaft (1606) by a net of cables (1602). The net of cables does not connect with the shaft, rather the net of cables binds opposing surfaces of the torus shape mass. The torus shape mass may comprise a variety of cross-sectional shapes, including: a circle, a square, a triangle, an ellipse, or other varieties of closed shapes. Like for the cases of the dumbbells, the net of cables provide the additional force for the centripetal acceleration that permits the system to rotate faster than conventional designs that do not have such cables. The latter are prevented from breaking by only the tensile strength of the rotating material itself. Additionally, in some embodiments the net of cables may be made of fibers that are relatively stronger and lighter that the material of the torus. Such an embodiment provides a stronger radial confining force that permits a greater rotational speed and a higher storage energy density before rupture occurs as compared to conventional flywheels. There is an annular space (1607) within the net of cables (1602).

Referring to FIG. 16B, a torus shape mass anchored to the central shaft by spokes and bound by a net of cables that are not anchored to the central shaft is depicted. In the embodiment shown, a doughnut shaped flywheel (11600) comprises a torus shaped mass (11601) anchored to the central shaft (11606) by spokes (11602) and bound by a net of cables (11607) that are not anchored to the central shaft (11606). The net of cables does not connect with the shaft, rather the net of cables binds opposing surfaces of the torus shaped mass.

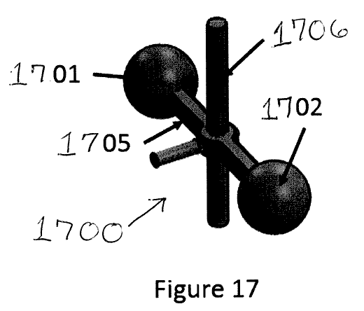

Referring to FIG. 17, a centrally tethered flywheel without cables (1700) is depicted. In some embodiments a dumbbell flywheel configuration is desired which comprises a first mass (1701) and a second mass (1702) each connected to a supporting arm (1705). The supporting arm (1705) is rotatably positioned about a shaft (1706) at a distance equidistant from each the first mass (1701) and the second mass (1702), and is securely attached to the rotating shaft (1706). The supporting arm (1705) may operate to facilitate the rotational acceleration the first mass (1701) and second mass (1702) with the shaft (1706).

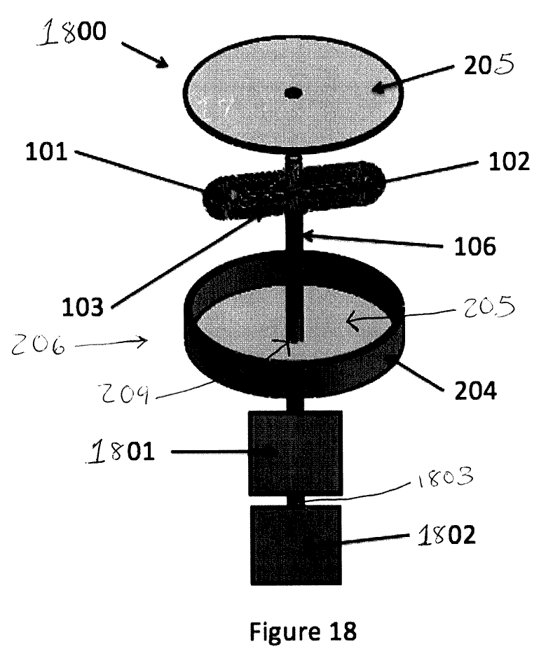

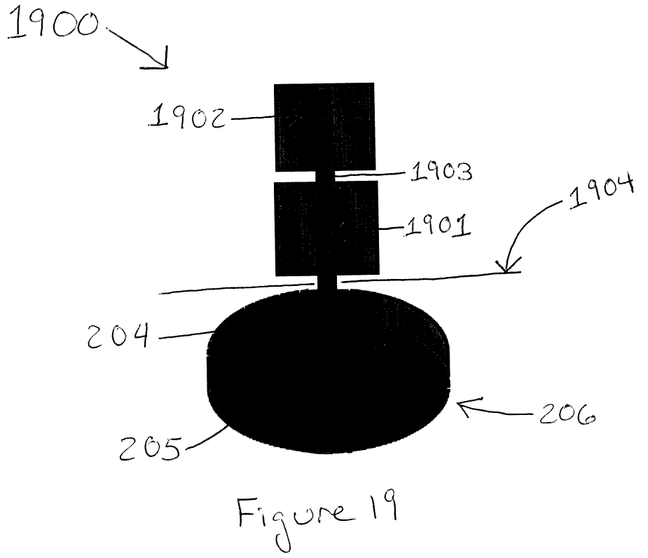

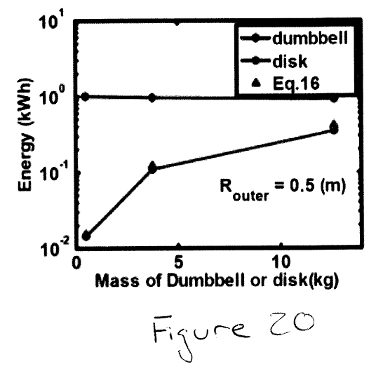

Referring to FIG. 18, an exemplary combination (1800) of a flywheel system centrally tethered flywheel rotating around a shaft inside a vertical enclosure connected to an electric motor (1801) and generator (1802) is depicted. If the motor (1801) and generator (1802) are separate components, they are connected by an electrical line (1803). FIG. 19 shows an embodiment designated as 1900 in which the vertical enclosure is buried beneath the ground (1904) and the motor (1901) and generator (1902) are positioned above the ground (1904). If the motor (1901) and generator (1902) are separate components, they are connected by an electrical line (1903).

In embodiments, the cable (103) comprises at least one of lead, cast iron, nodular iron, steel, high-strength steel, aluminum, ceramics, beryllium, titanium, high-strength aluminum alloys, high strength Magnesium alloys, titanium alloys, lead alloys, maraging steel, carbon fiber reinforced polymer, carbon fiber reinforced plastic, carbon fiber reinforced thermoplastic, glass reinforced plastic, or composites thereof. In embodiments, the diameter of the flywheel (100) is in the range of about 0.2 meters to about 10 meters, or about 0.4 meters to about 6 meters, or about 0.5 meters to about 2 meters.

In embodiments, the first and second masses (101, 102) comprise at least one of lead, cast iron, nodular iron, steel, high-strength steel, aluminum, ceramics, beryllium, titanium, high-strength aluminum alloys, high strength Magnesium alloys, titanium alloys, lead alloys, maraging steel, carbon fiber reinforced polymer, carbon fiber reinforced plastic, carbon fiber reinforced thermoplastic, glass reinforced plastic, or composites thereof

In embodiments, the housing (206) includes a hollow cylindrical vertical enclosure defined by a wall (204) enclosed by two opposite disk shaped ends (205). At least one end (205) has a cylindrical central opening (209) configured to receive the shaft (206). The housing (206) comprises at least one of stainless steel, aluminum, mild steel, brass, high-density ceramic, glass, acrylic, or composites thereof In embodiments, the housing (206) comprises material that can withstand the force of the first and/or second mass (101, 102) impacting the side of the housing (206) at a force generated from spinning at maximum rotations per minute. In embodiments, the diameter of the housing (206) is in the range of about 0.3 meters to about 5.1 meters, or about 0.5 meters to about 2.1 meters, or about 0.6 meters to about 1.1 meters. In embodiments, the diameter of the housing (206) is wide enough to enclose the flywheel (100) shown in FIG. 1. In embodiments, the height of the housing (206) is tall enough to enclose multiple flywheels. In embodiments, the wall thickness of the evacuated housing (206) is large enough to withstand the outside air pressure on the housing. The whole system is surrounded by another housing whose wall thickness is in the range of 100 cm to about 5 cm, or about 50 cm to about 10 cm, or about 40 cm to about 20. Design specifications for second surrounding housing may also require that this housing can withstand the force of the first and second masses (101, 102) impacting the inner housing wall and proceeding to the outer wall, in the event the supporting arm (105) breaks, preventing serious accidents. In embodiments, the housing (206) may comprise a chamber that is vacuum sealed. In some embodiments, the housing (206) includes an end (205) having a port (209). In some embodiments, the port (209) is covered with a vacuum feed through in order to preserve the vacuum seal while the shaft rotates. In some embodiments, the vacuum feed through comprises at least one of Buna rubber, Viton fluoropolymer, silicone rubber, or Teflon. In some embodiments, the vacuum feed through comprises material that can allow minimally restricted rotation of the shaft (106) under vacuum.

In embodiments, the shaft (106) comprises at least one of lead, cast iron, nodular iron, steel, high-strength steel, aluminum, ceramics, beryllium, titanium, high-strength aluminum alloys, high strength Magnesium alloys, titanium alloys, lead alloys, maraging steel, carbon fiber reinforced polymer, carbon fiber reinforced plastic, carbon fiber reinforced thermoplastic, glass reinforced plastic, or composites thereof.

In one embodiment, the flywheel (100) is placed around the shaft (106). The shaft (106) and flywheel (100) are placed in the housing (206) and the shaft (106) is inserted through the port (209). The port (209) is then sealed with a vacuum feed through. The electric motor (1801) and generator (1802) are then attached to the shaft (106) above the housing (206).

### Expected Performance

A comparison between the dumbbell construction and the conventional solid cylinders or tori shows in a basic manner that the dumbbell construction is superior in various aspects. In the various examples illustrated below, radii of each ball in the dumbbell (in units of m) are 0.112×n, with n=1, 2, 3. The density, ρ, of the material of the balls is that of steel, 7×10⁶ kg/m³.

It is assumed that there are two (2) cables wrapped around the outside of the balls of the dumbbell, going from one of the balls to the other, but not touching the central axis. The corresponding number of cables pointing radially is 2×2=4. The diameter of the cables and the radius, r, of the dumbbell are specified in the drawing; the tensile strength of the cable material is assumed to be that of a special steel, 1,640 MPa. But in the actual construction of the system, the cables will be made out of nanotube composites, with a tensile strength many times higher. The calculations are conservative since the cable strength is assumed to be 1,640 MPa. With a higher strength a larger rotation rate is possible, that leads to a larger storage of energy. The disk is a solid ring, whose outer radius, Rₒ, is equal to that of the outer radius of the dumbbell system (measured from the central axis to the outside of a ball), and the inner radius, Rᵢ, is equal to the outside radius minus the diameter of the ball. The mass of the disk is the same as that of the dumbbell. The tensile strength coefficient is the same as that of the cable, 1,640 MPa. The angular velocity limit of the spinning of the ring is calculated from a formula given for the tangential stress, σₜ, evaluated at the inner radius. The formula contains the Reynolds coefficient ν, and is given by Eq. (9.23a) in the book by R. L. Norton, Machine Design, an Integrated Approach, (Pearson Prentice Hall, 3^{rd} ed. (2006); Upper Saddle River, N.J. 07458)

$${σ}_{t} = ρ {ω}^{2} ( \frac{3 + v}{8} ) [ {R}_{i}^{2} + {R}_{0}^{2} + \frac{{( {R}_{i} {R}_{0} )}^{2}}{{r}^{2}} - \frac{1 + 3 v}{3 + v} {r}^{2} ] ; {R}_{i} \leq r \leq {R}_{0} . \qquad ( 1 )$$

The maximum angular rotation velocity ω is such that the largest value of σₜ in Eq. (1), that occurs for r=Ri, does not exceed the tensile strength of the material by a certain safety factor (that factor is taken as unity in the present comparison calculation). The results are shown below. They are calculated assuming that the dumbbell balls ate tethered to each other by two cables (four radially pointing strings) of diameter of 0.04 m each.

The triangles in the figures below are the results based on Eq. (16) of an unpublished paper by G. Rawitscher that is derived for a rotating disk. According to this paper Eq. (16) states that E=MT/(2ρ), where E is the maximum allowable rotational energy of a torus of mass M, ρ is the density of the material of the disk, and T is the maximum stress that the material of the torus is capable to tolerate before stretching or breaking. Equation (17) states that the rotational angular velocity ω of the torus described by Eq. (16) is given by ω=[T/(ρR²)]^{1/2}, where R is the radial distance from the center of rotation to center of the torus. (The torus is like a doughnut). The good agreement between the triangles and the results based on Eq. (1) is a confirmation that the calculations of Rawitscher are reliable.

FIG. 20: Maximum storage energy of a dumbbell compared with that of an equivalent disk, for three different radii of the balls of 0.2, 0.4, and 0.6 m. The masses of each ball are 0.23, 1.87, and 6.33 kg, respectively. The triangles give the results for the energy of a torus, based on Eq. (16), while the results for the disk are based on Eq. (1). The equivalent disk has the same mass as the dumbbell. The equivalent disk has the same outside and inside radii as the outside and inside radii of the dumbbell. The inside radius of the dumbbell is the length of the rod (1705) depicted in FIG. 17.

For a larger value of the outer radius the stored energy is, larger by a factor of approximately 2 while for the disk the energy is the same, since the mass is the same, in agreement with Eq. (16). The corresponding comparisons of the rotational speeds ω are shown in the next two figures. According to Eq. (17) the value of ω for the torus does not depend on the mass, but only on the mean radius R. Since the latter does not change appreciably with the size of the balls the difference is too small to be seen in the graph. However, for the dumbbell the value of ω decreases as the size of the balls increases, since the mass increases, and the required centripetal restraining force increases proportionally. The same considerations apply for a larger value of the outer radius. The value of ω decreases for both the dumbbells and the torus even though the stored energy increases for the dumbbell, while for the torus the energy remains the same.

FIG. 21: Comparison of the angular velocities of rotation ω of the dumbbells and the disks. The three points for each case correspond to dumbbells as described in FIG. 20 (above). The triangles illustrate the results for a disk, based on Eq. (17) in the text above.

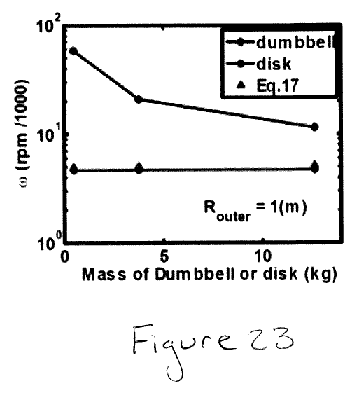

Similarly, FIG. 22, and FIG. 23 show similar results for a dumbbell having a larger radius, Rₒᵤₜₑᵣ=1 m.

The graphs show that the dumbbell arrangement of the rotating masses allows for storing a larger amount of energy than the equivalent disks, because the tethering cables are pointing centrally, and can be made of a modern composite material whose strength is higher than that of the material of the disks or of the balls. This advantage allows the device to be smaller and lighter than if constructed out of a solid disk, and hence is better suited for home installation and use. A further advantage of the dumbbells over the solid disk is that the dumbbells can be added to the flywheel system incrementally, in a staircase fashion, and also can be balanced individually and shipped individually.

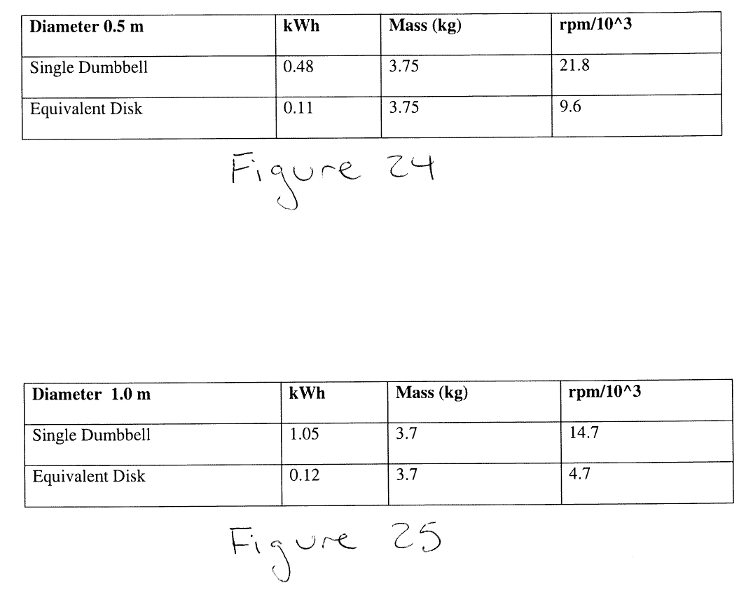

FIG. 24: Maximum storage energy of a dumbbell compared with that of an equivalent disk, for a diameter of 0.5 meter and a mass of 3.75 kg.

FIG. 25: Maximum storage energy of a dumbbell compared with that of an equivalent disk for a diameter of 1.0 meters and a mass of 3.7 kg.

The tables show that the dumbbell arrangement of the rotating masses allows for storing a larger amount of energy than the equivalent untethered disks, because the tethering cables are pointing centrally, and can be made of a modern composite material whose strength is higher than that of the material of the disks or of the balls. This advantage allows the device to be smaller and lighter than if constructed out of a solid disk, and hence is better suited for home installation and use. The tables also show that a dumbbell that has a larger diameter can rotate at a slower speed and store a larger amount of energy as compared to a dumbbell with a smaller diameter. A further advantage of the dumbbells over the solid disk is that the dumbbells can be added to the flywheel system incrementally, in a staircase fashion, and also can be balanced individually and shipped individually.

Six embodiments described in detail below include three dumbbell shaped and three torus shaped. These embodiments include two small flywheels (one a dumbbell, the other an “equivalent” torus) with outer radii of 0.21 m, two medium sized flywheels (one a dumbbell, the other an “equivalent” torus) with outer radii of 1.0 m, and two large flywheels (one a dumbbell, the other an “equivalent” torus) with outer radii of 3.0 m. In FIG. 16B, the webbing on the torus is provided by three cables wound around everywhere on the outside of the torus, going across the central axis, but not touching this axis. In addition several internal spokes connect the axis to the inside of the torus. Likewise for the dumbbells, each dumbbell is tethered by three cables tying one of the balls of the dumbbell to the opposite one, again without touching the central axis. The internal diameter of the ring (11601) is set equal to the diameter of the balls that make up the dumbbells, and the outer radius of the ring is the same as the one for the dumbbells. For this comparison the mass of the torus is larger than the mass of the system of dumbbells, because the space between the balls of the dumbbells is filled with material for the torus. The density of the rotating material is 7,000 kg/m³ and the tensile strength of the material (including the tethering ribbons) is 1,640.00 MPa. The number of cables tethering the dumbbell is 3 in each case. (Six strands, one in front of the ball, one behind).

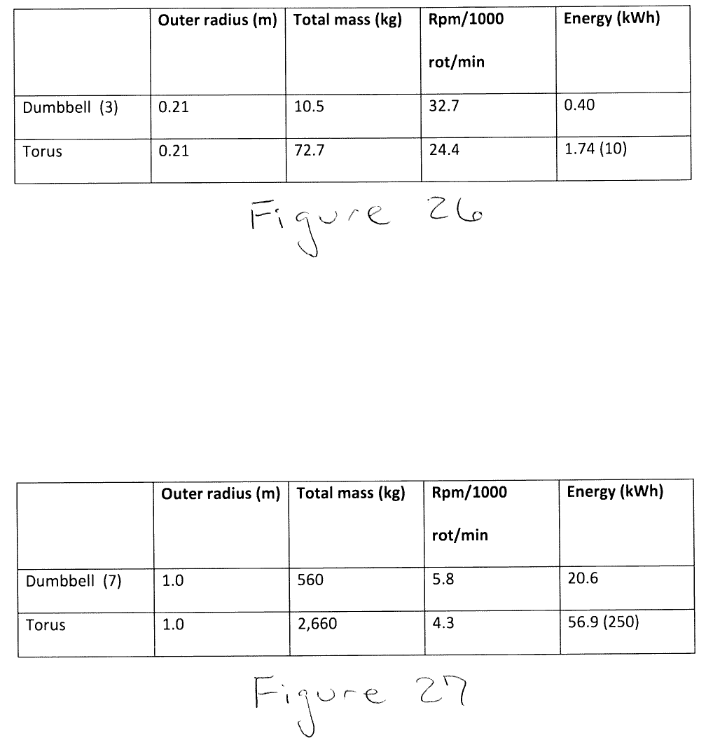

FIG. 26: Maximum storage energy of a dumbbell compared with that of an equivalent torus for a diameter of 0.42 meters. In this case the “equivalent” torus has the same outer and inner rotational radii as the ones of the dumbbell, as described in FIGS. 20 and 21, but the torus has the same inner circular cross sectional radius as the radii of the balls on the dumbbell, hence a larger mass than the dumbbell mass. The effect of the webbing, displayed in FIG. 16 B is not taken into account. An estimate of the effect of the webbing is shown by the numbers in parenthesis in the last column of the table.

The outer radius is 0.21 m for both torus and dumbbell. In this example there are three dumbbells (6 balls altogether), the diameter of each ball is 0.08 m, and the mass of each ball is 1.74 kg, the total mass of the dumbbell system is 10.5 kg. The corresponding torus has a mass of 72 kg. The diameter of each tethering strand is 0.02 m. The maximum energy stored in the system of dumbbell is 0.4 kWh and the maximum energy stored in the torus is 1.74 kWh. The energy densities are 0.038 and 0.023 kWh/kg, respectively. If webbing around the torus is included, then it can probably store 20 kWh (depending on the type of webbing), which is sufficient for home use per each night. For this case the torus embodiment is preferable over the system of dumbbells. This estimate is based on the following comparison: If the tethering cables around the dumbbells have only a diameter 0.01 m (as compared to 0.02 m) then the energy stored in the system of dumbbells decreases by a factor of 4.0 because the rpm decreases by a factor of 3.3. The calculations for the torus (shown in FIG. 26) assume no tethering. With tethering, a factor of 5 or larger is expected. The estimate is shown in parenthesis in the last column of FIG. 26.

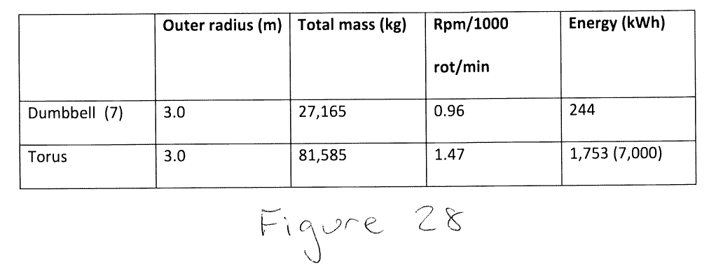

FIG. 27: Maximum storage energy of a dumbbell compared with that of an equivalent torus for a diameter of 2.0 meters.

The outer radius is 1.0 m for both torus and dumbbell. In this example there are seven dumbbells (14 balls altogether), the diameter of each ball is 0.22 m, and the mass of each ball is 40 kg, the total mass of the dumbbell system is 560 kg. The corresponding torus has a mass of 2,660 kg. The diameter of each tethering strand is 0.04 m. The maximum energy stored in the dumbbell is 21 kWh and the maximum energy stored in the torus is 57 kWh. The energy densities are 0.039 and 0.021 kWh/kg, respectively. If webbing around the torus is included, then it can probably store 250 kWh (depending on the type of webbing), which is sufficient for home use to replace the energy from an inoperative commercial electric grid for 6 day, sufficient to weather a storm. For this case, the dumbbell embodiment is preferable over the torus since it is sufficient to supply the energy for a household for more than 24 hours and is considerably less massive (0.6 tons) than the torus (2.7 tons).

FIG. 28: Maximum storage energy of a dumbbell compared with that of an equivalent torus for a diameter of 6.0 meters.

The outer radius is 3.0 m for both torus and dumbbell. In this example there are seven dumbbells (14 balls altogether), the diameter of each ball is 0.81 m, and the mass of each ball is 1,950 kg, the total mass of the dumbbell system is 27,300 kg. The corresponding torus has a mass of 81,600 kg. The diameter of each tethering strand is 0.08 m. The maximum energy stored in the system of dumbbell is 244 kWh and the maximum energy stored in the torus is 1,753 kWh. If tethering is included, about 7,000 kWh can be stored in the torus. The energy densities are 0.01 and 0.02 kWh/kg, respectively. For this case, the dumbbell embodiment is preferable over the torus since it is sufficient to supply the energy for a household for more than 10 days, and is considerably less massive (27 tons) than the torus (81 tons). To supply a cluster of houses, the torus would be preferable, since it could supply the household energy for seven houses for eight days of storms.

Prophetic Example One (tethered cable): A flywheel system is made that contains a dumbbell flywheel that is fixed to a rotating shaft. The dumbbell consists of a first and second masses connected by a cable. Each dumbbell has a mass of 2000 kg. The cable has a tensile strength of 1,640 MPa. The dumbbell has a diameter of 6 m. The dumbbell flywheel and the shaft are set within a housing. The housing is vacuum sealed. The housing consists of 10 cm thick steel. The shaft continues through a port at the top of the housing and connects to an electric motor and generator. The port is sealed with a flange. The housing is buried beneath the ground while the electric motor and generator are positioned above the surface.

The electric motor rotates the shaft allowing the dumbbell flywheel to spin and store energy. When that energy is needed, the generator is engaged withdrawing energy from the flywheel to be used as electrical energy elsewhere.

Prophetic Example Two (horizontal ribbon cable): A flywheel system is made that contains a dumbbell flywheel that rotates around a shaft. The dumbbell consists of a first and second mass connected by a ribbon cable wrapped around the sides of each mass as shown in

FIG. 5. Each dumbbell has a mass of 2000 kg. The ribbon cable has a tensile strength of 1,640.00 MPa. The dumbbell has a diameter of 5 m. The dumbbell flywheel and the shaft are set within a housing. The housing is vacuum sealed. The housing consists of 20 cm thick steel. The shaft continues through a port at the top of the housing and connects to an electric motor and generator. The port is sealed with a flange. The housing is buried beneath the ground while the electric motor and generator are positioned above the surface.

The electric motor rotates the shaft allowing the dumbbell flywheel to spin and store energy. When that energy is needed, the generator is engaged withdrawing energy from the flywheel to be used as electrical energy elsewhere.

Prophetic Example Three (vertical ribbon cable): A flywheel system is made that contains a dumbbell flywheel that is attached to a rotating shaft. The dumbbell consists of a first and second mass connected by a ribbon cable wrapped around the top and bottom of each mass as shown in FIG. 7. Each dumbbell has a mass of 2000 kg. The ribbon cable has a tensile strength of 1,640.00 MPa. The dumbbell has a diameter of 5 m. The dumbbell flywheel and the shaft are set within a housing. The housing is vacuum sealed. The housing consists of 20 cm thick steel. The shaft continues through a port at the top of the housing and connects to an electric motor and generator. The port is sealed with a flange. The housing is buried beneath the ground while the electric motor and generator are positioned above the surface.

The electric motor rotates the shaft allowing the dumbbell flywheel to spin and store energy. When that energy is needed, the generator is engaged withdrawing energy from the flywheel to be used as electrical energy elsewhere.

Prophetic Example Four (multiple dumbbells): A flywheel system is made that contains three dumbbell flywheels that are attached to a rotating shaft. The dumbbells consist of a first and second mass connected by a cable. Each dumbbell has a mass of 2000 kg. The cable has a tensile strength of 6,000 MPa. The dumbbells have a diameter of 5 m. The dumbbell flywheels and the shaft are set within a housing. The housing is vacuum sealed. The housing consists of 10 cm thick steel. The shaft continues through a port at the top of the housing and connects to an electric motor and generator. The port is sealed with a flange. The housing is buried beneath the ground while the electric motor and generator are positioned above the surface.

The electric motor rotates the shaft allowing the dumbbell flywheel to spin and store energy. When that energy is needed, the generator is engaged withdrawing energy from the flywheel to be used as electrical energy elsewhere.

Prophetic Example Five (multiple pairs on same horizontal plane): A flywheel system is made that contains a flywheel that is attached to a rotating shaft. The flywheel consists of three pairs of first and second masses connected by cables oriented about the shaft in the same horizontal plane. Each dumbbell has a mass of 2000 kg. The cables have a tensile strength of 5×10̂3 MPa. The flywheel has a diameter of 5 m. The flywheel and the shaft are set within a housing. The housing is vacuum sealed. The housing consists of 10 cm thick steel. The shaft continues through a port at the top of the housing and connects to an electric motor and electric generator. The port is sealed with a flange. The housing is buried beneath the ground while the electric motor and electric generator are positioned above the surface.

The electric motor rotates the shaft allowing the flywheel to spin and store energy. When that energy is needed, the generator is engaged withdrawing energy from the flywheel to be used as electrical energy elsewhere.

Prophetic Example Six (torus): A flywheel system is made that contains a torus flywheel that rotates and is attached to a shaft as shown in FIG. 16A. The flywheel system consists of a torus shape mass bound to the shaft by a net of cables. The torus shape has a mass of 81,600 kg. The net of cables has a tensile strength of 1,640.00 MPa. The torus has a diameter of 6 m. The torus flywheel and the shaft are set within a housing. The housing is vacuum sealed. The housing consists of 20 cm thick steel. The shaft continues through a port at the top of the housing and connects to an electric motor and generator. The port is sealed with a flange. The housing is buried beneath the ground while the electric motor and generator are positioned above the surface. If properly tethered, the torus could store 7,000 kWh of energy.

The electric motor rotates the shaft allowing the torus flywheel to spin and store energy. When that energy is needed, the generator is engaged withdrawing energy from the flywheel to be used as electrical energy elsewhere.

Prophetic Example Seven (above or on top of ground): A flywheel system is made that contains a dumbbell flywheel that is fixed to a rotating shaft. The dumbbell consists of a first and second mass connected by a cable. Each dumbbell has a mass of 2000 kg. The cable has a tensile strength of 5×10̂3 MPa. The dumbbell has a diameter of 5 m. The dumbbell flywheel and the shaft are set within a housing. The housing is vacuum sealed. The housing consists of 20 cm thick steel. The shaft continues through a port at the top of the housing and connects to an electric motor and generator. The port is sealed with a flange.

The electric motor rotates the shaft allowing the dumbbell flywheel to spin and store energy. When that energy is needed, the generator is engaged withdrawing energy from the flywheel to be used as electrical energy elsewhere.

The disclosed flywheel has many advantages. The configurations described above can rotate at a higher RPM due to the unique geometry and cable tethering thereby providing increased energy storage per mass and volume. As discussed above, this is achieved by creating a design that directs the constraining force, which prevents rupture, in the radial direction in contrast to the forces that act on conventional solid cylindrical flywheel rotors which act mainly in the tangential direction. In the embodiments described above the constraining force is provided by tethering cables of high strength that connect the rotating elements directly to each other. Additionally, in preferred embodiments the cables of high strength are only connected between the rotating elements, which are not connected to the axis or shaft at the center of the flywheel.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

What is claimed is:

1. A flywheel comprising:
at least one mass;
at least one cable encompassing the outside of the at least one mass;
wherein the at least one cable is configured to generate an opposing restraining force to the centripetal force generated from rotational motion of the at least one mass.

2. The flywheel of claim 1, wherein the at least one mass comprises first and second masses.

3. The flywheel of claim 1, wherein the at least one mass is disk shaped.

4. The flywheel of claim 1, wherein the at least one mass is torus shaped.

5. The flywheel of claim 2, wherein the at least one mass is dumbbell shaped.

6. The flywheel of claim 1, wherein the at least one cable comprises at least two cables.

7. The flywheel of claim 1, wherein the cable is tethered.

8. The flywheel of claim 1, wherein the cable comprises a vertical ribbon cable.

9. The flywheel of claim 1, wherein the cable comprises a horizontal ribbon cable.

10. The flywheel of claim 1, wherein the at least one mass comprises multiple dumbbell-shaped masses.

11. The flywheel of claim 2, further comprising:
a shaft;
a first support having a first end and a second end, the first end of the first support orthogonally connected to the shaft, the first mass being connected to the second end of the first support;
a second support having a first end and a second end, the first end of the second support orthogonally connected to the shaft wherein the first support and second support are on the same horizontal plane and extending in opposing directions from the shaft, the second mass being connected to the second end of the second support.

12. A flywheel comprising:
a torus shaped mass;
a shaft traversing the center of the torus shaped mass; and
a net of cables encircling the torus shaped mass, wherein the net of cables extend around outer surfaces of the torus shape mass while not contacting or connecting to the shaft.

13. A method of using the flywheel of claim 1 to store energy.

14. A method, comprising:
obtaining a flywheel comprising at least one mass, and at least one cable encompassing the outside of the at least one mass, wherein the at least one cable is configured to generate an opposing restraining force to the centripetal force generated from rotational motion of the at least one mass,
commencing rotation of the flywheel, and
extracting energy from the rotating flywheel.
